(19) United States
(12) Patent Application Publication
(10) Pub. No.: US 2007/0238597 A1
(43) Pub. Date: Oct. 11, 2007

(54) Interfolder with mass damper

(76) Inventors: James R. Michler, Ashland, WI (US); Brian L. Fiala JR., Thiensville, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/391,888

(22) Filed: Mar. 29, 2006

(51) Int. Cl. B31F 1/10

(52) U.S. Cl. 493/435

(57) ABSTRACT

An interfolding apparatus including a frame, a first interfolding roll supported for rotation by the frame, a second interfolding roll, and a mass damper. The first interfolding roll is rotatable about a first axis, and the second interfolding roll is rotatable about a second axis and is disposed adjacent to the first interfolding roll to define a nip therebetween. The first and second interfolding rolls are rotatable to contact each other during rotation, and the contact between the first and second interfolding rolls creates vibration of at least the first interfolding roll. The mass damper is coupled to the frame and absorbs at least a portion of the vibration energy of the first interfolding roll to reduce vibration of the first interfolding roll.

### BACKGROUND

The present invention relates generally to machines for manipulating web material, and more particularly to the use of mass dampers in connection with interfolding apparatuses.

The use of interfolding rolls to interfold sheets of web material is known in the art. During operation of a common interfolding apparatus, grippers and tuckers on one rotating interfolding roll interact with corresponding tuckers and grippers on an adjacent rotating interfolding roll. Each time this contact occurs, each interfolding roll is subject to a force, causing the roll to deflect. When the force is released, the roll vibrates. In most cases, this vibration eventually ceases after some number of vibration cycles.

The folding frequency, or the frequency of the contact described above, depends on the number of grippers and tuckers on each interfolding roll, as well as the speed at which the rolls are rotated. When the folding frequency is equal to, or a submultiple of, the natural frequency of vibration of the interfolding roll as installed in the interfolding apparatus, the amplitude of roll vibration builds up to a higher level. For each interfolding apparatus, folding frequencies causing these higher levels of vibration occur at specific roll rotation speeds. As interfolding rolls are made longer, the stiffness and natural frequency of vibration of the rolls decreases, causing increased levels of vibration that can prevent high speed operation of the interfolding apparatus.

### SUMMARY

In one embodiment, the invention provides an interfolding apparatus including a frame, a first interfolding roll supported for rotation by the frame, a second interfolding roll, and a mass damper. The first interfolding roll is rotatable about a first axis, and the second interfolding roll is rotatable about a second axis and is disposed adjacent to the first interfolding roll to define a nip therebetween. The first and second interfolding rolls are rotatable to contact each other during rotation, and the contact between the first and second interfolding rolls creates vibration of at least the first interfolding roll. The mass damper is coupled to the frame and absorbs at least a portion of the vibration energy of the first interfolding roll to reduce vibration of the first interfolding roll.

In another embodiment, the invention provides an apparatus for manipulating web material including a frame having a support member, a roll assembly supported for rotation by the support member at a location between the ends of the roll assembly, and a mass damper. The roll assembly has a first portion between the support member and a first end of the roll assembly, and a second portion between the support member and a second end of the roll assembly. The roll assembly is operable to contact an adjacent component during rotation of the roll assembly, and the contact between the roll assembly and the adjacent component creates vibration of the roll assembly. The mass damper is coupled to the frame and absorbs at least a portion of the vibration energy of the roll assembly to reduce vibration of the roll assembly.

In another embodiment, the invention provides a method of reducing vibration of a roll assembly including providing a frame having a support member, supporting the roll assembly for rotation with the support member at a location between the ends of the roll assembly, defining a first portion of the roll assembly between the support member and a first end of the roll assembly and a second portion of the roll assembly between the support member and a second end of the roll assembly, coupling a mass damper to the frame, rotating the roll assembly, creating vibration of the roll assembly from contact between the roll assembly and an adjacent component during rotation of the roll assembly, transferring at least a portion of the vibration energy of the roll assembly through at least a portion of the frame to the mass damper, absorbing the vibration energy with the mass damper, and reducing the amplitude of the vibration of the roll assembly.

In another embodiment, the invention provides a method of operating an apparatus for manipulating web material at a desired operating speed. The method includes providing a frame, providing a roll assembly, supporting the roll assembly for rotation with the frame such that the roll assembly has a natural frequency of vibration as supported for rotation, positioning an adjacent component such that the roll assembly is operable to contact the adjacent component during rotation of the roll assembly, changing the natural frequency of vibration of the roll assembly, as supported for rotation, by coupling a spring-mounted mass structure to the frame, and rotating the roll assembly at a speed such that contact between the roll assembly and the adjacent component applies an intermittent force to the roll assembly at a frequency that is substantially the same as the natural frequency of vibration of the roll assembly as supported for rotation without the spring-mounted mass coupled to the frame.

Other aspects of the invention will become apparent by consideration of the detailed description and accompanying drawings.

### BRIEF DESCRIPTION OF THE DRAWINGS

FIG. 1 is a side view illustrating an interfolding apparatus including a mass damper in accordance with one embodiment of the present invention.

FIG. 2 is a top view of a portion of the interfolding apparatus shown in FIG. 1, illustrating a single interfolding roll assembly coupled to a mass damper, with the mass damper shown in partial cross-section taken along line 2-2 in FIG. 1.

FIG. 3 is a view similar to FIG. 2, illustrating a single interfolding roll assembly coupled to a mass damper in accordance with another embodiment of the present invention, with the mass damper shown in cross-section.

FIG. 4 is an enlarged cross-section view of the mass damper shown in FIG. 2.

FIG. 5 is an enlarged cross-section view of the mass damper shown in FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Phraseology and terminology used herein with reference to device or element orientation (such as, for example, terms like “front,” “back,” “up,” “down,” “top,” “bottom,” and the like) are only used to simplify description of the present invention, and do not alone indicate or imply that the device or element referred to must have a particular orientation. In addition, terms such as “first,” “second,” and “third” are used herein and in the appended claims for purposes of description and are not intended to indicate or imply relative importance or significance. The use of “including,” “comprising,” or “having” and variations thereof herein is meant to encompass the items listed thereafter and equivalents thereof, and can include additional items. Unless specified or limited otherwise, the terms “mounted,” “connected,” “supported,” and “coupled” and variations thereof are used broadly and encompass both direct and indirect mounting, connecting, supporting, and coupling. Further, “connected” and “coupled” are not restricted to physical or mechanical connections or couplings.

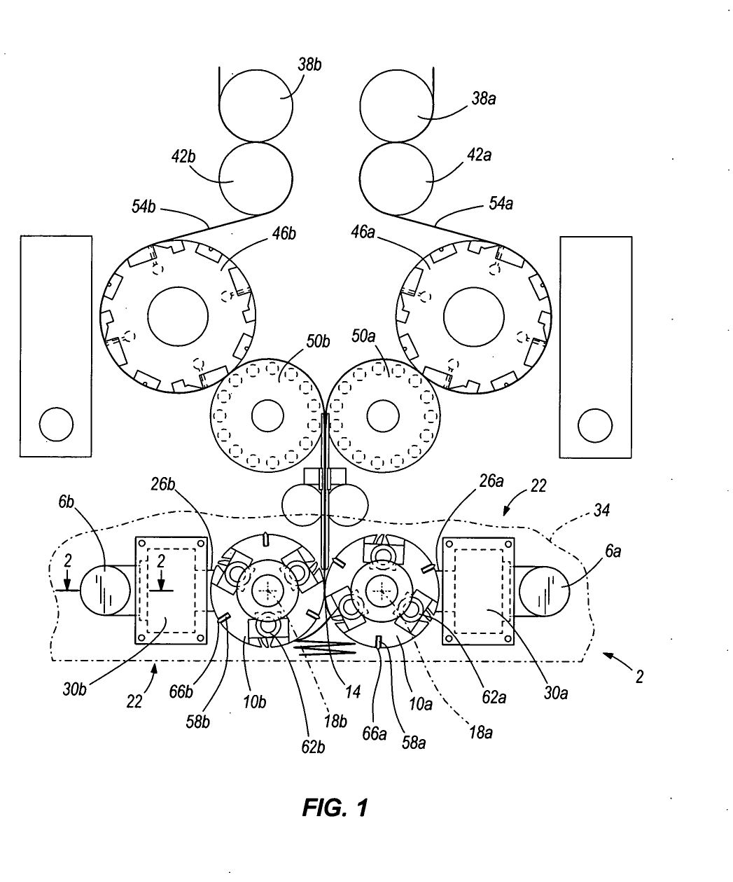

FIG. 1 illustrates an interfolding apparatus 2 incorporating mass dampers 6a, 6b in accordance with one embodiment of the present invention. The interfolding apparatus 2 includes interfolding roll assemblies 10a, 10b positioned adjacent to one another to form a nip 14. The interfolding roll assemblies 10a, 10b are mounted for rotation about axes 18a, 18b. The interfolding apparatus 2 shown in FIG. 1 also includes a frame 22 that can be constructed in a wide variety of shapes, but is illustrated including support members 26a, 26b, support beams 30a, 30b, and side structures 34. The side structures 34 are shown in phantom in FIG. 1. As described in greater detail below, the interfolding roll assemblies 10a, 10b are supported for rotation by the frame 22. In addition to the interfolding roll assemblies 10a, 10b, the frame 22, and the mass dampers 6a, 6b, the interfolding apparatus 2 as shown in FIG. 1 also includes outer pull rolls 38a, 38b, inner pull rolls 42a, 42b, knife rolls 46a, 46b, and transfer rolls 50a, 50b for feeding sheets of web material to the interfolding roll assemblies 10a, 10b. Instead of these specific roll components, however, an interfolding apparatus according to the present invention can include any other combination of components in order to feed sheets of web material to the interfolding roll assemblies 10a, 10b.

The interfolding apparatus 2 is capable of interfolding streams of continuously flowing web material 54a, 54b. As illustrated in FIG. 1, the interfolding apparatus 2 includes two sides that are mirror images of one another. Side “a” is structurally similar and performs the same functions as side “b,” only that the movement is opposite to that of side “b.” For example, clockwise rotation of a roll on side “b” would mean that the complementary roll on side “a” would have counterclockwise rotation.

As illustrated in FIG. 1, the interfolding roll assemblies 10a, 10b include tuckers 58a, 58b and grippers 62a, 62b. The tuckers 58a, 58b protrude from the periphery of the interfolding roll assemblies 10a,10b and end at a point 66a, 66b. The grippers 62a, 62b are each positioned between adjacent tuckers 58a, 58b. The interfolding roll assembly 10b shown in FIG. 1 includes three tuckers 58b and three grippers 62b, disposed alternately around the interfolding roll assembly 10b. Alternatively, the interfolding roll assembly 10b can have a different number of tuckers 58b and grippers 62b to accommodate the specific application of the interfolding apparatus 2.

During operation of the interfolding apparatus 2, the interfolding roll assembly 10b rotates clockwise, and the adjacent interfolding roll assembly 10a rotates counterclockwise. Each tucker 58b of the interfolding roll assembly 10b is received in a corresponding gripper 62a of the adjacent interfolding roll assembly 10a as the tucker 58b rotates through the nip 14. Likewise, each gripper 62b of the interfolding roll assembly 10b receives a corresponding tucker 58a of the adjacent interfolding roll assembly 10a as the gripper 62b rotates through the nip 14. The succession of sheets of web material entering the nip 14 is such that a middle portion of a reference sheet from side “a” enters the nip at the same time as trailing and leading edges of downstream and upstream sheets, respectively, from side “b.” As the tucker 58b and corresponding gripper 62a rotate through the nip, the tucker 58b tucks the middle portion of the reference sheet into the gripper 62a. The gripper 62a receives the middle portion of the reference sheet and the trailing and leading edges of the downstream and upstream sheets, respectively, from the tucker 58b and folds the middle portion of the reference sheet, capturing the trailing and leading edges of the downstream and upstream sheets, respectively, within the fold.

As the interfolding roll assembly 10b continues rotation, a gripper 62b of the interfolding roll assembly 10b receives a middle portion of the upstream sheet from side “b,” the trailing edge of the reference sheet, and the leading edge of another sheet from side “a,” which is upstream from the reference sheet, from a corresponding tucker 58a of the adjacent interfolding roll assembly 10a. The folding process continues in this alternating fashion.

When the tuckers 58b and grippers 62b of the interfolding roll assembly 10b contact the corresponding tuckers 58a and grippers 62a of the adjacent interfolding roll assembly 10a during each fold, forces are applied to the interfolding roll assembly 10b. The frequency of this contact during operation of the interfolding apparatus 2 will be referred to herein as the folding frequency. As illustrated by the above discussion, the folding frequency depends on the number of tuckers and grippers that the interfolding roll assemblies 10a, 10b include, as well as the speed at which the interfolding roll assemblies 10a, 10b are rotated.

In one embodiment of the interfolding apparatus 2, the interfolding roll assembly 10b includes three tuckers and three grippers and produces an interfolded stack of web material measuring about 4.9 inches in width. The interfolding apparatus 2 is operated at about 650 feet per minute, resulting in a folding frequency of about 26.5 Hz. During operation of this embodiment of the interfolding apparatus 2, the force on the roll assembly 10b rises to about 300 pounds during each fold, and remains at about 300 pounds for about 4 degrees of rotation of the roll assembly 10b.

While the interfolding roll assembly 10b is subjected to the force from the folding contact, the roll assembly 10b deflects. When the folding contact between the roll assemblies 10a, 10b ceases, the force is removed and the roll assembly 10b rebounds and vibrates at its natural frequency as supported for rotation. In most cases, this vibration eventually ceases after some number of vibration cycles. However, with respect to the interfolding apparatus 2 without the mass dampers 6a, 6b, when the folding frequency of the interfolding apparatus 2 is about equal to, or a submultiple of, the natural frequency of vibration of the interfolding roll assembly 10b as supported for rotation by the frame 22, the amplitude of vibration of the roll assembly 10b can increase to undesirable levels. For example, referring to the embodiment described above, if the roll assembly 10b, as supported for rotation by the frame 22 and without the mass damper 6b, had a natural frequency of vibration of 26.5 Hz, operating the interfolding apparatus 2 at 650, 325, or 217 feet per minute would cause the amplitude of vibration of the roll assembly 10b to build up. In accordance with the present invention, one or more mass dampers 6b are used to control vibration of the interfolding roll assembly 10b, as will be explained in greater detail below.

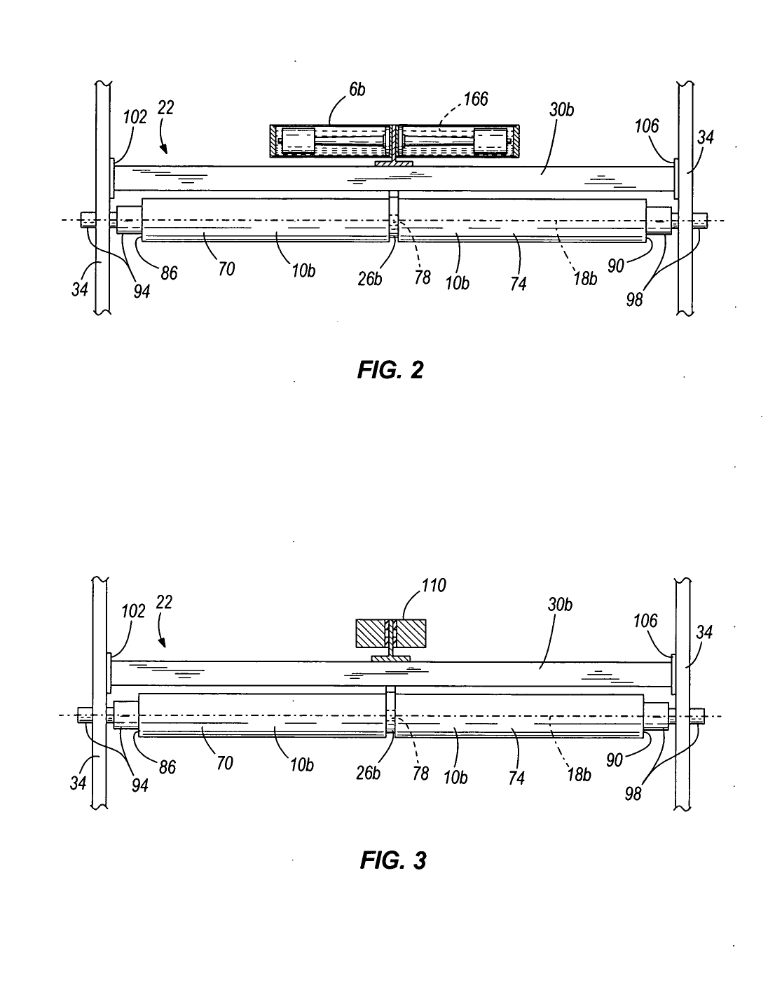

FIG. 2 shows a top view of a portion of the interfolding apparatus 2 shown in FIG. 1, illustrating the interfolding roll assembly 10b coupled to the mass damper 6b in accordance with one embodiment of the present invention. The mass damper 6b is shown in partial cross-section taken along line 2-2 in FIG. 1.

As shown in FIG. 2, in one embodiment of the present invention the interfolding roll assembly 10b includes a first roll portion 70 and a second roll portion 74 rotatable about a common axis 18b. In other embodiments, the interfolding roll assembly 10b can include more than two roll portions, or can include just one roll portion. In the embodiment shown in FIG. 2, the first roll portion 70 and second roll portion 74 are connected by a common center shaft 78. The roll assembly 10b is supported for rotation between the first roll portion 70 and the second roll portion 74 by the support member 26b. The support member 26b can include a bearing, or any other component or combination of components that can be used to support a shaft for rotation.

It is often preferable to use an interfolding roll assembly that includes just one continuous roll portion if the roll portion is less than about 80 inches long. If, to meet product objectives, the roll portion used is about 80 inches or longer, it is often desirable to instead use an interfolding roll assembly that includes multiple portions and is supported for rotation between the ends of the roll assembly to reduce vibration of the roll assembly. As shown in FIG. 2, the roll assembly 10b is supported for rotation by the support member 26b at about the center of the roll assembly 10b measured between the end surfaces 86, 90 of the roll assembly 10b. In other embodiments, the roll assembly 10b could be supported for rotation at other points along the axis of rotation 18b of the roll assembly 10b. As also shown in FIG. 2, end shaft sections 94, 98 protrude from the end surfaces 86, 90 of the roll assembly 10b and are supported for rotation by the side structures 34. The roll assembly 10b can be rotatably driven by a motor (not shown) mechanically coupled to one of the end shaft sections 94, 98, or by any other device or combination of devices that can be used to rotate an object.

As shown in FIG. 2, the frame 22 includes the side structures 34, the support beam 30b, and the support member 26b. As described above, the side structures 34 are positioned so that the roll assembly 10b extends between them, and the end shaft sections 94, 98 are each supported for rotation by one of the side structures 34. As shown, the support beam 30b is positioned on a side of the roll assembly 10b and extends between the side structures 34. Like other elements of the interfolding apparatus 2 described and illustrated herein, the support beam 30b can have any shape and size (e.g., solid or tubular, having a rectangular, round, or any other cross-sectional shape). The support beam 30b has a length dimension that is longer than its cross-section dimensions, and the length dimension of the support beam 30b is oriented parallel to the axis of rotation 18b of the roll assembly 10b. The support beam 30b is mounted to the side structures 34 at each end 102, 106 of the support beam 30b. In other embodiments, the support beam 30b can be positioned and oriented differently relative to the roll assembly 10b. For example, the support beam 30b can be positioned above the roll assembly 10b. In the embodiment of the present invention illustrated in FIG. 2, the support member 26b is coupled to the support beam 30b.

As also shown in the embodiment illustrated in FIG. 2, the mass damper 6b is indirectly coupled to the interfolding roll assembly 10b through components of the frame 22. As shown, the mass damper 6b is mounted to the support beam 30b at a location along the length dimension of the support beam 30b that is about centered between the end surfaces 86, 90 of the roll assembly 10b. The mass damper 6b is shown mounted to the support beam 30b at this location because the roll assembly 10b experiences its maximum vibration amplitude at the center of the roll assembly 10b measured between the end surfaces 86, 90 of the roll assembly 10b. In other embodiments, the mass damper 6b can be mounted to the support beam 30b at other locations on the support beam 30b. In addition, more than one mass damper can be mounted to the support beam 30b. Further, the one or more mass dampers can be mounted to other components of the frame 22, rather than the support beam 30b.

Similar to FIG. 2, FIG. 3 again shows a top view of a portion of the interfolding apparatus 2 illustrated in FIG. 1, except in FIG. 3 the mass damper 6b has been replaced by a mass damper 110 according to another embodiment of the present invention. The mass damper 110 is shown in cross-section.

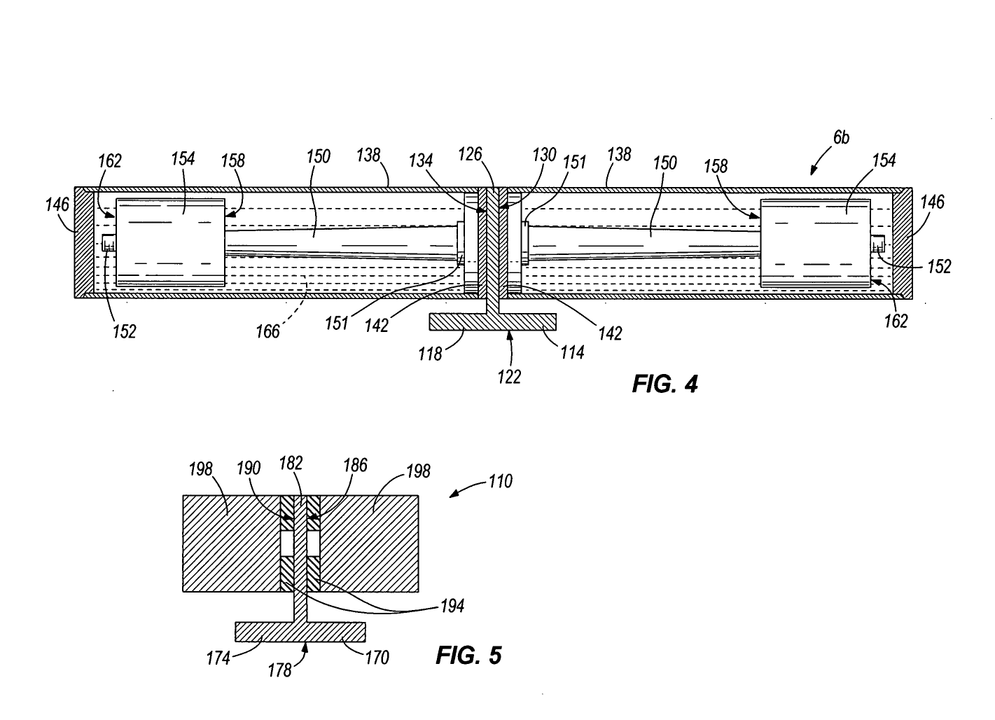

FIG. 4 shows an enlarged view of the mass damper 6b illustrated in FIGS. 1-2. The mass damper 6b is illustrated in partial cross-section taken along line 2-2 in FIG. 1. As shown in FIG. 4, the mass damper 6b includes a mounting member 114. The mounting member 114 shown in FIG. 4 has a base 118 with a flat bottom surface 122 and an attachment projection 126 that extends from the base 118 in a direction perpendicular to the bottom surface 122. In other embodiments, the mounting member 114 can have any other shape and size. The base 118 of the mounting member 114 can be mounted to the frame 22, and more specifically, in some embodiments of the present invention, is mounted to the support beam 30b, as shown in FIG. 2. The attachment projection 126 of the mounting member 114 has opposite facing sides 130, 134. Containers 138 are coupled to each of the opposite facing sides 130, 134. As shown, the containers 138 are hollow cylindrical tubes capped at one end with an inner cap 142 that is coupled to a side 130, 134 of the attachment projection 126, and capped at the other end with an outer cap 146. In other embodiments, the containers 138 can have cross-sections other than cylindrical, such as square, hexagonal, octagonal, and the like, and can be constructed of any number of pieces, including a one-piece construction.

As shown in FIG. 4, a spring element 150 is positioned within each container 138. In the embodiment shown in FIG. 4, the spring elements 150 are cylindrical bars. In other embodiments, the spring elements 150 can be bars with cross-section shapes other than cylindrical, coil springs, or any other structures suitable to act as a spring element. The spring elements 150 can be constructed of any material or combination of materials, such as steel, aluminum, or other metals, plastic, fiberglass, composite materials, and the like. As shown in FIG. 4, the spring elements 150 are coupled at one end to the inner caps 142 of the containers 138. In other embodiments, the spring elements 150 can be coupled at one end 151 to the mounting member 114, rather than the containers 138. The other ends 152 of the spring elements 150 are suspended within the hollow containers 138 and, in the embodiment shown, are free to move in any direction substantially perpendicular to the longitudinal axes of the spring elements 150. In other embodiments, the free ends 152 of the spring elements 150 can move in any directions. An example embodiment of the present invention includes spring elements 150 in the form of cylindrical bars that are about 18 inches long and have a cross-section that narrows from a diameter of about 2 inches at the fixed end 151 to about 1 inch at the free end 152. In other embodiments, as stated above, the spring elements 150 can have any other dimensions, cross-section shapes, or structures that may be suitable for this application. A cylindrical mass 154 is coupled to each of the spring elements 150 in a manner such that the free end 152 of the spring elements 150 extends through the center of each of the end surfaces 158, 162 of the cylindrical masses 154 along the axes of the cylindrical masses 154. The masses 154 can have any shape and size (e.g., solid or tubular, having a rectangular, round, or any other cross-sectional shape). In addition, the masses can be coupled to the spring elements in other ways, such as fixed to the ends 152 or sides of the spring elements 150. In the embodiment shown, the masses 154 can move in any directions substantially perpendicular to the longitudinal axes of the spring elements 150 by deflecting the spring elements 150. In other embodiments, the masses 154 can move in any directions by deflecting the spring elements 150. As described herein, movement in a “direction” refers to, for example, moving to the left or moving to the right. Thus, for example, moving up and down in a generally vertical plane, or moving side to side in a generally horizontal plane, would be movement in two directions.

The remaining volume in the interior of the containers 138, as illustrated in FIG. 4, can be partly or completely filled with a damping fluid 166. The damping fluid 166 can be any fluid, but examples of fluids that are suitable for use as a damping fluid in embodiments of the present invention are silicone damping fluids and petroleum oil. Silicone damping fluids are particularly suitable for use in embodiments of the present invention because, compared to petroleum oils, they experience less change in viscosity as a result of changes in temperature. Therefore, the damping properties of silicone damping fluids fluctuate less due to temperature changes than the damping properties of petroleum oils. Suitable silicone damping fluids for use in embodiments of the present invention are available from DOW CORNING.

As described in detail above, in the embodiments illustrated in FIGS. 1-2, the interfolding roll assembly 10b is supported for rotation by the frame 22, and, more specifically, the support member 26b, between the end surfaces 86, 90 of the roll assembly 10b. End shaft sections 94, 98 protrude from the end surfaces 86, 90 of the roll assembly 10b. The end shaft sections 94, 98 are also supported for rotation by the frame, but by the side structures 34 rather than the support member 26b.

As supported for rotation by the frame 22, the roll assembly 10b has a natural frequency of vibration. As supported, the roll assembly 10b can have different natural frequencies of vibration when vibrating in different spatial planes. For example, vertical vibration of the roll assembly 10b can have a different natural frequency of vibration than horizontal vibration of the roll assembly 10b. Description herein of embodiments and operation of the present invention will be confined to vibration of the roll assembly 10b in a single spatial plane, and thus, a single natural frequency of vibration for the roll assembly 10b. The natural frequency of vibration of the roll assembly 10b, as supported for rotation, can be dependent upon the characteristics of other components of the interfolding apparatus 2, as well as characteristics of the operating environment of the interfolding apparatus 2. For example, the type and structure of a floor or surface supporting the interfolding apparatus 2 can affect the natural frequency of vibration of the roll assembly 10b as supported for rotation.

When the mass damper 6b is added to the interfolding apparatus 2 by coupling the mass damper 6b to the frame 22, the combined system as shown in FIG. 2, including the roll assembly 10b and the mass damper 6b, then has two natural frequencies of vibration, one (Frequency A) higher than the natural frequency of vibration of the roll assembly 10b as supported and without the mass damper 6b coupled to the frame 22 and one (Frequency B) lower than the natural frequency of vibration of the roll assembly 10b as supported and without the mass damper 6b coupled to the frame 22. The mass damper 6b can be tuned to a specific damped natural frequency of vibration by selecting appropriate spring elements 150, masses 154, and damping fluid 166. Ideally, the mass damper 6b is tuned to a damped natural frequency of vibration as close as possible to the natural frequency of vibration of the roll assembly 10b as supported for rotation and without the mass damper 6b coupled to the frame 22. However, the mass damper 6b will function to reduce vibration of the roll assembly 10b if the mass damper 6b is tuned to a damped natural frequency of vibration between Frequency A and Frequency B.

The difference between Frequency A and Frequency B, and how close Frequency A and Frequency B are to the natural frequency of vibration of the roll assembly 10b as supported for rotation and without the mass damper 6b coupled to the frame 22, depends upon the ratio of the mass of the masses 154 to the mass of the roll assembly 10b. The greater the mass of the masses 154, the greater the difference is between Frequency A and Frequency B and the greater the respective differences are between Frequencies A and B and the natural frequency of vibration of the roll assembly 10b as supported for rotation and without the mass damper 6b coupled to the frame 22. In addition, the smaller the mass of the masses 154, the smaller the difference is between Frequency A and Frequency B and the smaller the respective differences are between Frequencies A and B and the natural frequency of vibration of the roll assembly 10b as supported for rotation and without the mass damper 6b coupled to the frame 22.

Thus, when tuning the mass damper 6b to a damped natural frequency of vibration between Frequency A and Frequency B, using heavier masses 154 results in a wider range of damped natural frequencies (of the mass damper 6b) that will function effectively to reduce vibration of the roll assembly 10b, and therefore the tuning does not have to be as precise. Using heavier masses 154 can therefore help to make sure the mass damper 6b will function effectively to reduce vibration of the roll assembly in multiple spatial planes, because the range of damped natural frequencies (of the mass damper 6b) that will function effectively to reduce vibration of the roll assembly 10b is wider for each orientation of vibration. In addition, because the viscosity of the damping fluid 166 can vary with temperature, the damped natural frequency of vibration of the mass damper 6b can also vary with temperature. Thus, using heavier masses 154 can potentially provide a wide enough range of damped natural frequencies that will function effectively to reduce vibration of the roll assembly 10b to accommodate variation of the damped natural frequency of vibration of the mass damper 6b due to temperature variation. As a result, when tuning the mass damper 6b, it can be advantageous to use the heaviest masses 154 that accommodate any practical constraints, such as space constraints and the like. In some embodiments, it is preferable to use mass dampers having moving mass totaling greater than 5% of the mass of the roll assembly 10b. As shown in FIG. 4, this means that the combined mass of the two masses 154 is greater than 5% of the mass of the roll assembly 10b. In other embodiments, a suitable mass damper 6b can have a total moving mass that is substantially 10% of the mass of the roll assembly 10b. Above substantially 10%, the benefit of using a large mass is minimized and the masses 154 can be larger than is practically preferred for use in embodiments of the present invention. The mass of the roll assembly 10b can be calculated by combining the masses of the first and second roll portions 70, 74, the common center shaft 78, and the end shaft sections 94, 98.

According to some embodiments of the invention, to tune the mass damper 6b, the interfolding apparatus 2, including the frame 22, the roll assembly 10b, the adjacent roll assembly 10a, and any other components, is first fully assembled in its intended operating environment without the mass damper 6b. The roll assembly 10b is then caused to vibrate and measurements are taken with a measurement device suitable for taking data that can be used to determine the natural frequency of vibration of the roll assembly 10b as supported for rotation. A suitable measurement device for use in this application is an accelerometer. From this data, the natural frequency of vibration of the roll assembly 10b as supported for rotation is determined. The mass damper 6b is then tuned to a damped natural frequency that is appropriate to effectively reduce vibration of the roll assembly 10b during operation of the interfolding apparatus 2. There are four variables that can be controlled in order to tune the mass damper 6b: the masses 154 used, the damping properties of the damping fluid 166 used, the spring constant of the spring elements 150 used, and the directions that the masses 154 of the mass damper 6b can vibrate in.

During testing and tuning of various mass dampers according to embodiments of the present invention, the Applicant discovered that adding the damping fluid to the mass damper 6b, in addition to adding a damping component, changes the natural frequency of the mass 154 and spring element 150 combinations. This effect is a function of the fluid specific gravity, and is caused by the kinetic energy of the damping fluid 166 flowing around the masses 154.

As described above, folding contact during operation of the interfolding apparatus 2 causes vibration of the interfolding roll assembly 10b. Vibration of the interfolding roll assembly 10b causes the masses 154 to vibrate. Through movement of the masses 154 and spring elements 150 within the containers 138, the mass damper 6b absorbs at least a portion of the vibration energy of the interfolding roll assembly 10b, as supported for rotation by the frame 22, to reduce the vibration of the interfolding roll assembly 10b. The damping component of the damping fluid 166 absorbs vibration energy from the moving masses 154 and spring elements 150, thereby reducing vibration of the masses 154, and converts the vibration energy to heat.

As stated above, adding the mass damper 6b to the interfolding apparatus 2 creates a combined system, including the roll assembly 10b and the mass damper 6b, that has two natural frequencies of vibration, one (Frequency A) higher than the natural frequency of vibration of the roll assembly 10b as supported and without the mass damper 6b coupled to the frame 22 and one (Frequency B) lower than the natural frequency of vibration of the roll assembly 10b as supported and without the mass damper 6b coupled to the frame 22. Accordingly, vibration of the roll assembly 10b can increase to undesirable levels if the folding frequency of the interfolding apparatus 2 is equal to, or a submultiple of, Frequency A or Frequency B, but the roll assembly 10b will not vibrate excessively if the folding frequency is equal to, or a submultiple of, the natural frequency of vibration of the roll assembly 10b as supported and without the mass damper 6b coupled to the frame 22. Thus, if a specific desired operating speed results in a folding frequency equal to, or a submultiple of, the natural frequency of vibration of the roll assembly 10b as supported and without any mass damper coupled to the frame, a simple spring-mounted mass (not shown) can be attached to the frame, instead of a mass damper, to operate the interfolding apparatus 2 at this desired operating speed. Attaching the spring-mounted mass will create a combined system, including the roll assembly 10b and the spring-mounted mass, that has two natural frequencies, as described above with reference to Frequency A and Frequency B. Operating the interfolding apparatus 2 at the desired operating speed is no longer a problem, therefore, because the interfolding apparatus 2 can be accelerated through any lower speeds resulting in excessive vibration and operated below any higher speeds resulting in excessive vibration.

For example, with reference to the embodiment described above (no mass damper) having three tuckers and three grippers and producing an interfolded stack of web material measuring about 4.9 inches in width, if the natural frequency of vibration of the roll assembly 10b, as supported for rotation and without the mass damper 6b, is 26.5 Hz, operating the interfolding apparatus 2 at about 650, 325, or 217 feet per minute would result in a folding frequency of about 26.5 Hz, or a submultiple thereof, and would cause the amplitude of vibration of the roll assembly 10b to build up. If a spring-mounted mass is coupled to the frame 22, the combined system, including the spring-mounted mass and the roll assembly 10b, might have natural frequencies of vibration of, for example, 24.5 Hz and 28.5 Hz (not actual measurements). As a result, operating the interfolding apparatus 2 at about 600, 300, or 200 feet per minute, as well as about 698, 349, and 233 feet per minute, would result in folding frequencies of about 24.5 Hz and 28.5 Hz or submultiples thereof, respectively, and would cause vibration of the roll assembly 10b to build up. The interfolding apparatus 2 of this embodiment could accelerate through speeds of 200, 233, 300, 349, and 600 feet per minute, and operate at 650 feet per minute.

FIG. 5 is an enlarged cross-sectional view of the mass damper 110 shown in FIG. 3. As shown in FIG. 5, the mass damper 110 includes a mounting member 170. The mounting member 170 shown in FIG. 5 has a base 174 with a flat bottom surface 178 and an attachment projection 182 that extends from the base 174 in a direction perpendicular to the bottom surface 178. In other embodiments, the mounting member 170 can have any other shape and size. The base 174 of the mounting member 170 can be mounted to the frame 22, and more specifically, in some embodiments of the present invention, is mounted to the support beam 30b, as shown in FIG. 3. The attachment projection 182 of the mounting member 170 has opposite facing sides 186, 190. Spring elements 194 are coupled to each of the opposite facing sides 186, 190. As shown in the embodiment of the present invention illustrated in FIG. 5, the spring elements 194 are donut-shaped elastomeric members. In other embodiments, the spring elements 194 can have any other shape and size (e.g., thicker or thinner than shown in FIG. 5, having a square, triangular, hexagonal, or any other cross-sectional shape), and can be constructed of any other material or combination of materials with suitable spring and damping properties to allow a mass 198 to vibrate and to dampen the allowed vibrations of the mass 198. Suitable elastomeric members for use in the present invention include LORD Corporation Two-Piece Mounts. In addition, within the category of elastomeric materials, viscoelastic materials are suitable for use as a combination spring and damper in embodiments of the present invention. As shown in FIG. 5, the spring elements 194 are coupled on one side to the mounting member 170, and on the other side to masses 198. In some embodiments, a bolt (not shown) is passed through the center of the mass 198 and the spring element 194 to fasten them to the mounting member 170. The bolt can be tightened to compress the spring element 194 between the mounting member 170 and the mass 198. The masses 198 can have any shape and size (e.g., solid or tubular, having a rectangular, round, or any other cross-sectional shape). In the embodiment shown, the masses 198 can move in any directions substantially perpendicular to the axes of the donut-shaped spring elements 194 by deflecting the spring elements 194. In other embodiments, the masses 198 can move in any directions by deflecting the spring elements 194. As described herein, movement in a “direction” refers to, for example, moving to the left or moving to the right. Thus, for example, moving up and down in a generally vertical plane, or moving side to side in a generally horizontal plane, would be movement in two directions.

As described in detail above with regard to FIGS. 1-2, in the embodiment illustrated in FIG. 3, the interfolding roll assembly 10b is supported for rotation by the frame 22, and, more specifically, the support member 26b, between the end surfaces 86, 90 of the roll assembly 10b. End shaft sections 94, 98 protrude from the end surfaces 86, 90 of the roll assembly 10b. The end shaft sections 94, 98 are also supported for rotation by the frame 22, but by the side structures 34 rather than the support member 26b.

As discussed above, the roll assembly 10b has a natural frequency of vibration as supported for rotation. When the mass damper 110 is added to the interfolding apparatus 2 by coupling the mass damper 110 to the frame 22, the combined system as shown in FIG. 2, including the roll assembly 10b and the mass damper 110, then has two natural frequencies of vibration, one (Frequency A) higher than the natural frequency of vibration of the roll assembly 10b as supported and without the mass damper 110 coupled to the frame 22 and one (Frequency B) lower than the natural frequency of vibration of the roll assembly 10b as supported and without the mass damper 110 coupled to the frame 22. The mass damper 110 can be tuned to a specific damped natural frequency of vibration by selecting appropriate spring elements 194 and masses 198. Ideally, the mass damper 110 is tuned to a damped natural frequency of vibration as close as possible to the natural frequency of vibration of the roll assembly 10b as supported for rotation and without the mass damper 110 coupled to the frame 22. However, the mass damper 110 will function to reduce vibration of the roll assembly 10b if the mass damper 110 is tuned to a damped natural frequency of vibration between Frequency A and Frequency B.

The difference between Frequency A and Frequency B, and how close Frequency A and Frequency B are to the natural frequency of vibration of the roll assembly 10b as supported for rotation and without the mass damper 110 coupled to the frame 22, depends upon the ratio of the mass of the masses 198 to the mass of the roll assembly 10b. The greater the mass of the masses 198, the greater the difference is between Frequency A and Frequency B and the greater the respective differences are between Frequencies A and B and the natural frequency of vibration of the roll assembly 10b as supported for rotation and without the mass damper 110 coupled to the frame 22. In addition, the smaller the mass of the masses 198, the smaller the difference is between Frequency A and Frequency B and the smaller the respective differences are between Frequencies A and B and the natural frequency of vibration of the roll assembly 10b as supported for rotation and without the mass damper 110 coupled to the frame 22.

Thus, when tuning the mass damper 110 to a damped natural frequency of vibration between Frequency A and Frequency B, using heavier masses 198 results in a wider range of damped natural frequencies (of the mass damper 110) that will function effectively to reduce vibration of the roll assembly 10b, and therefore the tuning does not have to be as precise. Using heavier masses 198 can therefore help to make sure the mass damper 110 will function effectively to reduce vibration of the roll assembly in multiple spatial planes, because the range of damped natural frequencies (of the mass damper 110) that will function effectively to reduce vibration of the roll assembly 10b is wider for each orientation of vibration. In addition, because the spring constant and damping properties of the elastomeric spring elements 194 can vary with temperature, the damped natural frequency of vibration of the mass damper 110 can also vary with temperature. Thus, using heavier masses 198 can potentially provide a wide enough range of damped natural frequencies that will function effectively to reduce vibration of the roll assembly 10b to accommodate variation of the damped natural frequency of vibration of the mass damper 110 due to temperature variation. As a result, when tuning the mass damper 110, it can be advantageous to use the heaviest masses 198 that accommodate any practical constraints, such as space constraints and the like. In some embodiments, it is preferable to use mass dampers having moving mass totaling greater than 5% of the mass of the roll assembly 10b. As shown in FIG. 5, this means that the combined mass of the two masses 198 is greater than 5% of the mass of the roll assembly 10b. In other embodiments, a suitable mass damper 110 can have a total moving mass that is substantially 10% of the mass of the roll assembly 10b. Above substantially 10%, the benefit of using a large mass is minimized and the masses 198 can be larger than is practically preferred for use in embodiments of the present invention. The mass of the roll assembly 10b can be calculated by combining the masses of the first and second roll portions 70, 74, the common center shaft 78, and the end shaft sections 94, 98.

According to some embodiments of the invention, to tune the mass damper 110, the interfolding apparatus 2, including the frame 22, the roll assembly 10b, the adjacent roll assembly 10a, and any other components, is first fully assembled in its intended operating environment without the mass damper 110. The roll assembly 10b is then caused to vibrate and measurements are taken with a measurement device suitable for taking data that can be used to determine the natural frequency of vibration of the roll assembly 10b as supported for rotation. A suitable measurement device for use in this application is an accelerometer. From this data, the natural frequency of vibration of the roll assembly 10b as supported for rotation is determined. The mass damper 110 is then tuned to a damped natural frequency that is appropriate to effectively reduce vibration of the roll assembly 10b during operation of the interfolding apparatus 2. There are four variables that can be controlled in order to tune the mass damper 110: the masses 198 used, the damping properties of the spring elements 194 used, the spring constant of the spring elements 194 used, and the directions that the masses 198 of the mass damper 110 can vibrate in.

As described above, folding contact during operation of the interfolding apparatus 2 causes vibration of the interfolding roll assembly 10b. Vibration of the interfolding roll assembly 10b causes the masses 198 to vibrate. Through movement of the masses 198 and spring elements 194, the mass damper 110 absorbs at least a portion of the vibration energy of the interfolding roll assembly 10b, as supported for rotation by the frame 22, to reduce the vibration of the interfolding roll assembly 10b. The damping component of the spring elements 194 takes vibration energy from the moving masses 198 and spring elements 194, thereby reducing vibration of the masses 198, and converts the vibration energy to heat.

In other embodiments of the present invention, any other type of mass damper can be used in combination with the interfolding apparatus 2 to reduce vibration of the interfolding roll assembly 10b. For example, eddy current damping, using permanent magnets and electrical conductors, can be used to damp vibration of masses.

In still other embodiments of the present invention, the mass dampers 6b, 110, as well as any other type of mass damper, can be used in combination with any other apparatus for manipulating web material. The mass dampers can be used to reduce the vibration of rolls or roll assemblies other than just interfolding rolls and interfolding roll assemblies.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. For example, the various embodiments (and alternatives thereto) of the present invention described above and illustrated in the figures are not mutually exclusive of one another. With the exception of features, elements, and manners of operation that are mutually exclusive of or are inconsistent with one another, the features, elements and manners of operation of any of the embodiments can be employed in any of the other embodiments in any combination.

What is claimed is:

1. An interfolding apparatus comprising:
a frame;
a first interfolding roll supported for rotation by the frame, the first interfolding roll rotatable about a first axis;
a second interfolding roll rotatable about a second axis, the second interfolding roll disposed adjacent to the first interfolding roll to define a nip therebetween, the first and second interfolding rolls rotatable to contact each other during rotation, wherein the contact between the first and second interfolding rolls creates vibration of at least the first interfolding roll; and
a mass damper coupled to the frame and arranged to absorb at least a portion of the vibration energy of the first interfolding roll to reduce vibration of the first interfolding roll.

2. The interfolding apparatus of claim 1, wherein the mass damper includes:
a mounting member coupled to the frame;
a spring element coupled to the mounting member; and
a mass coupled to the spring element for movement in at least two directions.

3. The interfolding apparatus of claim 2, wherein the spring element includes an elastomer.

4. The interfolding apparatus of claim 1, wherein the mass damper includes:
a mounting member coupled to the frame;
a container coupled to the mounting member;
a viscous damping fluid disposed within the container;
a spring element coupled to at least one of the mounting member and the container and positioned within the container; and
a mass coupled to the spring element for movement in at least two directions.

5. The interfolding apparatus of claim 1, wherein the frame includes a support member, wherein the first interfolding roll is supported for rotation by the support member at a location approximately centered between the ends of the first interfolding roll along the first axis, and wherein the mass damper is coupled to the support member.

6. The interfolding apparatus of claim 5, wherein the frame includes a support beam, wherein the support member is coupled to the support beam, and wherein the mass damper is mounted to the support beam.

7. The interfolding apparatus of claim 6, wherein the frame includes two side structures, wherein one of the side structures rotatably supports one end of the first interfolding roll and the other of the side structures rotatably supports the other end of the first interfolding roll, and wherein the support beam is coupled between the side structures.

8. The interfolding apparatus of claim 1, wherein the first interfolding roll as supported by the frame has a natural frequency of vibration, and wherein the mass damper is tuned to a damped natural frequency of vibration substantially the same as the natural frequency of vibration of the first interfolding roll.

9. The interfolding apparatus of claim 1, wherein the mass damper has a total moving mass that is greater than 5% of the mass of the first interfolding roll.

10. The interfolding apparatus of claim 1, wherein the mass damper has a total moving mass that is substantially 10% of the mass of the first interfolding roll.

11. An apparatus for manipulating web material, the apparatus comprising:
a frame having a support member;
a roll assembly supported for rotation by the support member at a location between the ends of the roll assembly, the roll assembly having a first portion between the support member and a first end of the roll assembly and a second portion between the support member and a second end of the roll assembly, wherein the roll assembly is operable to contact an adjacent component during rotation of the roll assembly, wherein the contact between the roll assembly and the adjacent component creates vibration of the roll assembly; and
a mass damper coupled to the frame and arranged to absorb at least a portion of the vibration energy of the roll assembly to reduce vibration of the roll assembly.

12. The apparatus of claim 11, wherein the mass damper comprises:
a mounting member coupled to the frame;
a spring element coupled to the mounting member; and
a mass coupled to the spring element for movement in at least two directions.

13. The apparatus of claim 12, wherein the spring element includes an elastomer.

14. The apparatus of claim 11, wherein the mass damper comprises:
a mounting member coupled to the frame;
a container coupled to the mounting member;
a viscous damping fluid disposed within the container;
a spring element coupled to at least one of the mounting member and the container and positioned within the container; and
a mass coupled to the spring element for movement in at least two directions.

15. The apparatus of claim 11, wherein the roll assembly as supported for rotation by the frame has a natural frequency of vibration, and wherein the mass damper is tuned to a damped natural frequency of vibration substantially the same as the natural frequency of vibration of the roll assembly.

16. The apparatus of claim 11, wherein the first portion of the roll assembly and the second portion of the roll assembly are rotatable about a common axis of rotation.

17. The apparatus of claim 16, wherein the first portion of the roll assembly and the second portion of the roll assembly are rotatable with a common shaft.

18. The apparatus of claim 16, wherein the first portion of the roll assembly and the second portion of the roll assembly are about equal in length measured along the axis of rotation of the roll assembly.

19. The apparatus of claim 16, wherein the frame includes side structures and a support beam coupled between the side structures, wherein one of the side structures rotatably supports the first end of the roll assembly and the other of the side structures rotatably supports the second end of the roll assembly.

20. The apparatus of claim 11, wherein the frame includes a support beam coupled to the support member, and wherein the mass damper is mounted to the support beam.

21. The apparatus of claim 11, wherein the support member includes a bearing supporting the roll assembly for rotation.

22. The apparatus of claim 11, wherein the mass damper has a total moving mass that is greater than 5% of the mass of the roll assembly.

23. The apparatus of claim 11, wherein the mass damper has a total moving mass that is substantially 10% of the mass of the roll assembly.

24. A method of reducing vibration of a roll assembly, the method comprising:
providing a frame having a support member;
supporting the roll assembly for rotation with the support member at a location between the ends of the roll assembly;
defining a first portion of the roll assembly between the support member and a first end of the roll assembly and a second portion of the roll assembly between the support member and a second end of the roll assembly;
coupling a mass damper to the frame;
rotating the roll assembly;
creating vibration of the roll assembly from contact between the roll assembly and an adjacent component during rotation of the roll assembly;
transferring at least a portion of the vibration energy of the roll assembly through at least a portion of the frame to the mass damper;
absorbing the vibration energy with the mass damper; and
reducing the amplitude of the vibration of the roll assembly.

25. The method of claim 24, wherein absorbing the vibration energy includes deflecting a spring element and moving a mass coupled to the spring element.

26. The method of claim 25, wherein absorbing the vibration energy includes damping the motion of the mass, and reducing the amplitude of the motion of the mass.

27. The method of claim 26, wherein damping the motion of the mass includes damping the motion of the mass with an elastomeric spring element.

28. The method of claim 26, wherein damping the motion of the mass includes positioning the mass and the spring element within a container and damping the motion of the mass with a viscous damping fluid within the container.

29. The method of claim 24, further comprising:
tuning the mass damper to a damped natural frequency of vibration that is substantially the same as the natural frequency of vibration of the roll assembly as supported for rotation by the frame.

30. The method of claim 29, wherein tuning the mass damper includes configuring the mass damper to have a total moving mass that is greater than 5% of the mass of the roll assembly.

31. The method of claim 29, wherein tuning the mass damper includes configuring the mass damper to have a total moving mass that is substantially 10% of the mass of the roll assembly.

32. The method of claim 24, wherein supporting the roll assembly for rotation includes supporting the roll assembly at about the center of the roll assembly between the ends of the roll assembly.

33. A method of operating an apparatus for manipulating web material at a desired operating speed, the method comprising:
providing a frame;
providing a roll assembly;
supporting the roll assembly for rotation with the frame such that the roll assembly has a natural frequency of vibration as supported for rotation;
positioning an adjacent component such that the roll assembly is operable to contact the adjacent component during rotation of the roll assembly;
changing the natural frequency of vibration of the roll assembly, as supported for rotation, by coupling a spring-mounted mass structure to the frame;
rotating the roll assembly at a speed such that contact between the roll assembly and the adjacent component applies an intermittent force to the roll assembly at a frequency that is substantially the same as the natural frequency of vibration of the roll assembly as supported for rotation without the spring-mounted mass coupled to the frame.

34. The method of claim 33, wherein coupling a spring-mounted mass structure to the frame includes providing a damping component for the spring-mounted mass structure.

35. The method of claim 33, wherein changing the natural frequency of vibration of the roll assembly, as supported for rotation, includes replacing the natural frequency of vibration of the roll assembly, as supported for rotation without the spring-mounted mass structure coupled to the frame, with one natural frequency lower than the natural frequency of vibration of the roll assembly as supported for rotation without the spring-mounted mass structure coupled to the frame, and one natural frequency higher than the natural frequency of vibration of the roll assembly as supported for rotation without the spring-mounted mass structure coupled to the frame.
